(19) United States
(12) Patent Application Publication
(10) Pub. No.: US 2017/0295159 A1
(43) Pub. Date: Oct. 12, 2017

(54) Authenticating Clients Using Tokens

(71) Applicant: Bank of America Corporation, Charlotte, NC (US)

(72) Inventors: Ashish Arora, Bellevue, WA (US); Vikram Jalota, Bellevue, WA (US); Andrew T. Keys, Albany, OR (US)

(21) Appl. No.: 15/091,754

(22) Filed: Apr. 6, 2016

(51) Int. Cl. H04L 29/06

(52) U.S. Cl. CPC H04L 63/083; H04L 67/42; H04L 63/102

(57) ABSTRACT

A computing platform may receive, from a client communication server, a first token request requesting a token for a first client. The computing platform may generate a first token linked to a first record associated with the first client. Subsequently, the computing platform may send, to the client communication server, the first token linked to the first record associated with the first client. Thereafter, the computing platform may receive, from a client portal server, a first token validation request comprising the first token linked to the first record associated with the first client, and may validate the first token linked to the first record associated with the first client. Based on validating the first token, the computing platform may send, to the client portal server, a first token validation message directing the client portal server to provide the first record associated with the first client to the first client.

### BACKGROUND

Aspects of the disclosure relate to authenticating clients using tokens. In particular, one or more aspects of the disclosure relate to providing information security and preventing unauthorized access to resources of an information system by authenticating one or more clients using one or more client-specific tokens.

As organizations increasingly provide electronic portals via which various users may access, view, and/or modify information, including client information, ensuring the safety and security of information maintained by such organizations and/or made available via such portals is increasingly important. In many instances, however, it may be difficult to ensure the safety and security of such information while also optimizing the efficient and effective technical operations of the computer systems that maintain such information and/or provide such portals.

### SUMMARY

Aspects of the disclosure provide effective, efficient, scalable, and convenient technical solutions that address and overcome the technical problems associated with providing information security and preventing unauthorized access to resources of an information system by authenticating one or more clients using one or more client-specific tokens.

In accordance with one or more embodiments, a computing platform having at least one processor, a memory, and a communication interface may receive, via the communication interface, and from a client communication server, a first token request requesting a token for a first client. Based on receiving the first token request requesting the token for the first client, the computing platform may generate a first token linked to a first record associated with the first client. Subsequently, the computing platform may send, via the communication interface, and to the client communication server, the first token linked to the first record associated with the first client. Thereafter, the computing platform may receive, via the communication interface, and from a client portal server, a first token validation request comprising the first token linked to the first record associated with the first client. Based on receiving the first token validation request comprising the first token linked to the first record associated with the first client, the computing platform may validate the first token linked to the first record associated with the first client. Based on validating the first token linked to the first record associated with the first client, the computing platform may send, via the communication interface, and to the client portal server, a first token validation message directing the client portal server to provide the first record associated with the first client to the first client.

In some embodiments, prior to generating the first token linked to the first record associated with the first client, the computing platform may evaluate one or more authentication security factors associated with the first client to determine to generate the first token linked to the first record associated with the first client.

In some embodiments, evaluating the one or more authentication security factors associated with the first client may comprise evaluating one or more of device login history information associated with the first client, network address login history information associated with the first client, or login trend information associated with the first client.

In some embodiments, the first record may comprise user account details information associated with the first client. In some embodiments, the client communication server may be configured to send one or more messages to one or more client devices. In some embodiments, the client portal server may be configured to provide one or more client portal interfaces to one or more client devices.

In some embodiments, validating the first token linked to the first record associated with the first client may comprise: sending, via the communication interface, and to a registered device associated with the first client, a one-time passcode; and validating one-time passcode input received from the client portal server.

In some embodiments, validating the first token linked to the first record associated with the first client may comprise: sending, via the communication interface, and to the client portal server, one or more security questions associated with the first client; and validating security question response input received from the client portal server.

In some embodiments, the computing platform may receive, via the communication interface, and from the client communication server, a second token request requesting a token for a second client different from the first client. Based on receiving the second token request requesting the token for the second client, the computing platform may generate a second token linked to a second record associated with the second client. Subsequently, the computing platform may send, via the communication interface, and to the client communication server, the second token linked to the second record associated with the second client. Thereafter, the computing platform may receive, via the communication interface, and from the client portal server, a second token validation request comprising the second token linked to the second record associated with the second client. Based on receiving the second token validation request comprising the second token linked to the second record associated with the second client, the computing platform may validate the second token linked to the second record associated with the second client. Based on validating the second token linked to the second record associated with the second client, the computing platform may send, via the communication interface, and to the client portal server, a second token validation message directing the client portal server to provide the second record associated with the second client to the second client.

In some embodiments, prior to generating the second token linked to the second record associated with the second client, the computing platform may evaluate one or more authentication security factors associated with the second client to determine to generate the second token linked to the second record associated with the second client.

In some embodiments, evaluating the one or more authentication security factors associated with the second client may comprise evaluating one or more of device login history information associated with the second client, network address login history information associated with the second client, or login trend information associated with the second client.

In some embodiments, the second record may comprise user account details information associated with the second client.

In some embodiments, validating the second token linked to the second record associated with the second client may comprise: sending, via the communication interface, and to a registered device associated with the second client, a one-time passcode; and validating one-time passcode input received from the client portal server.

In some embodiments, validating the second token linked to the second record associated with the second client may comprise: sending, via the communication interface, and to the client portal server, one or more security questions associated with the second client; and validating security question response input received from the client portal server.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for authenticating clients using tokens in accordance with one or more example embodiments;

FIGS. 2A-2K depict an illustrative event sequence for authenticating clients using tokens in accordance with one or more example embodiments;

FIGS. 3 and 4 depict example graphical user interfaces for authenticating clients using tokens in accordance with one or more example embodiments; and

FIG. 5 depicts an illustrative method for authenticating clients using tokens in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Aspects of the disclosure relate to providing tokenized access to specific account details. For example, a customer contact server may obtain a plurality of tokenized links from a customer authentication server, and the tokenized links may enable one or more customers to access specific account details, such as account statements, account balance information, recent transaction history information, and/or the like. The customer authentication server may apply different authentication rules to different customers, depending on the individual customer's risk state, when the tokenized links are returned to the authentication server and used by the customers to request account information.

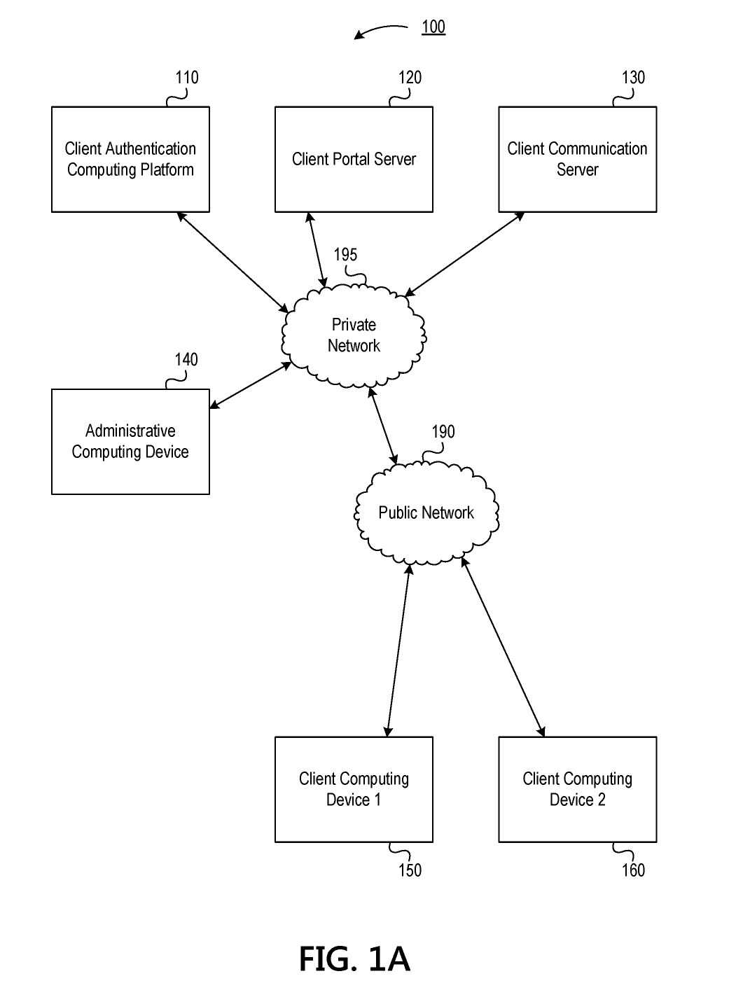

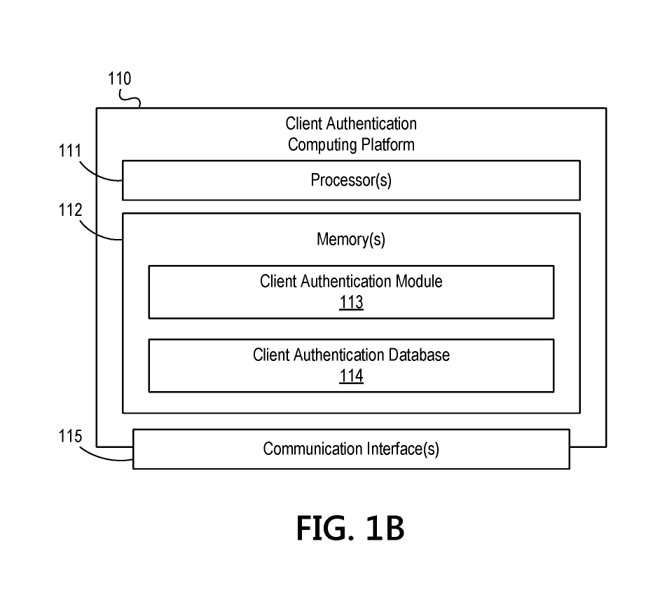

FIGS. 1A and 1B depict an illustrative computing environment for authenticating clients using tokens in accordance with one or more example embodiments. Referring to FIG. 1A, computing environment 100 may include one or more computing devices. For example, computing environment 100 may include a client portal server 120, a client communication server 130, an administrative computing device 140, a first client computing device 150, and a second client computing device 160.

Client portal server 120 may be configured to provide one or more portal interfaces to one or more client devices. For example, client portal server 120 may be configured to provide a customer portal, such as an online banking portal, to one or more customers of an organization, such as a financial institution, who may use one or more client computing devices to access the portal, such as client computing device 150 and/or client computing device 160, as illustrated in greater detail below. In some instances, in addition to being configured to provide an online banking portal associated with a financial institution to one or more customers of the financial institution and/or their associated computing devices, client portal server 120 also may be configured to provide a mobile banking portal associated with the financial institution to various customers of the financial institution and/or their associated mobile computing devices. Such portals may, for instance, provide customers of the financial institution with access to financial account information (e.g., account balance information, account statements, recent transaction history information, or the like) and/or may provide customers of the financial institution with menus, controls, and/or other options to schedule and/or execute various transactions (e.g., online bill pay transactions, person-to-person funds transfer transactions, or the like).

Client communication server 130 may be configured to generate and/or send one or more messages to one or more client devices. For example, client communication server 130 may be configured to generate and/or send one or more account messages, advertising messages, and/or other messages to one or more customers of an organization, such as a financial institution, who may use one or more client computing devices to access the portal, such as client computing device 150 and/or client computing device 160, as illustrated in greater detail below. For instance, client communication server 130 may be configured to generate and/or send notifications to client computing device 150, client computing device 160, and/or one or more other client computing devices to inform the users of such devices when new account information is available (e.g., when new financial account statements are available, when other new documents are available, or the like), when user-specific deals and/or other offers are available, and/or when other information selected for the users of such devices is available.

Administrative computing device 140 may be configured to provide one or more interfaces that allow for configuration and management of one or more other computing devices and/or computer systems included in computing environment 100. Client computing device 150 may be configured to be used by a first customer of an organization, such as a financial institution. Client computing device 160 may be configured to be used by a second customer of the organization (who may, e.g., be different from the first customer of the organization).

In one or more arrangements, client portal server 120, client communication server 130, administrative computing device 140, client computing device 150, and client computing device 160 may be any type of computing device capable of receiving a user interface, receiving input via the user interface, and communicating the received input to one or more other computing devices. For example, client portal server 120, client communication server 130, administrative computing device 140, client computing device 150, and client computing device 160 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of client portal server 120, client communication server 130, administrative computing device 140, client computing device 150, and client computing device 160 may, in some instances, be special-purpose computing devices configured to perform specific functions.

Computing environment 100 also may include one or more computing platforms. For example, computing environment 100 may include client authentication computing platform 110. As illustrated in greater detail below, client authentication computing platform 110 may include one or more computing devices configured to perform one or more of the functions described herein. For example, client authentication computing platform 110 may include one or more computers (e.g., laptop computers, desktop computers, servers, server blades, or the like).

Computing environment 100 also may include one or more networks, which may interconnect one or more of client authentication computing platform 110, client portal server 120, client communication server 130, administrative computing device 140, client computing device 150, and client computing device 160. For example, computing environment 100 may include public network 190 and private network 195. Private network 195 and/or public network 190 may include one or more sub-networks (e.g., local area networks (LANs), wide area networks (WANs), or the like). Private network 195 may be associated with a particular organization (e.g., a corporation, financial institution, educational institution, governmental institution, or the like) and may interconnect one or more computing devices associated with the organization. For example, client authentication computing platform 110, client portal server 120, client communication server 130, and administrative computing device 140 may be associated with an organization (e.g., a financial institution), and private network 195 may be associated with and/or operated by the organization, and may include one or more networks (e.g., LANs, WANs, virtual private networks (VPNs), or the like) that interconnect client authentication computing platform 110, client portal server 120, client communication server 130, and administrative computing device 140 and one or more other computing devices and/or computer systems that are used by, operated by, and/or otherwise associated with the organization. Public network 190 may connect private network 195 and/or one or more computing devices connected thereto (e.g., client authentication computing platform 110, client portal server 120, client communication server 130, and administrative computing device 140) with one or more networks and/or computing devices that are not associated with the organization. For example, client computing device 150 and client computing device 160 might not be associated with an organization that operates private network 195 (e.g., because client computing device 150 and client computing device 160 may be owned, operated, and/or serviced by one or more entities different from the organization that operates private network 195, such as one or more customers of the organization and/or vendors of the organization, rather than being owned and/or operated by the organization itself or an employee or affiliate of the organization), and public network 190 may include one or more networks (e.g., the internet) that connect client computing device 150 and client computing device 160 to private network 195 and/or one or more computing devices connected thereto (e.g., client authentication computing platform 110, client portal server 120, client communication server 130, and administrative computing device 140).

Referring to FIG. 1B, client authentication computing platform 110 may include one or more processors 111, memory 112, and communication interface 115. A data bus may interconnect processor(s) 111, memory 112, and communication interface 115. Communication interface 115 may be a network interface configured to support communication between client authentication computing platform 110 and one or more networks (e.g., private network 195, public network 190, or the like). Memory 112 may include one or more program modules having instructions that when executed by processor(s) 111 cause client authentication computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of client authentication computing platform 110 and/or by different computing devices that may form and/or otherwise make up client authentication computing platform 110. For example, memory 112 may have, store, and/or include a client authentication module 113 and a client authentication database 114. Client authentication module 113 may have instructions that direct and/or cause client authentication computing platform 110 to authenticate one or more clients and/or devices associated with clients using one or more tokens and/or perform other functions, as discussed in greater detail below. Client authentication database 114 may store information used by client authentication module 113 and/or client authentication computing platform 110 in authenticating one or more clients and/or devices associated with clients using one or more tokens and/or in performing other functions.

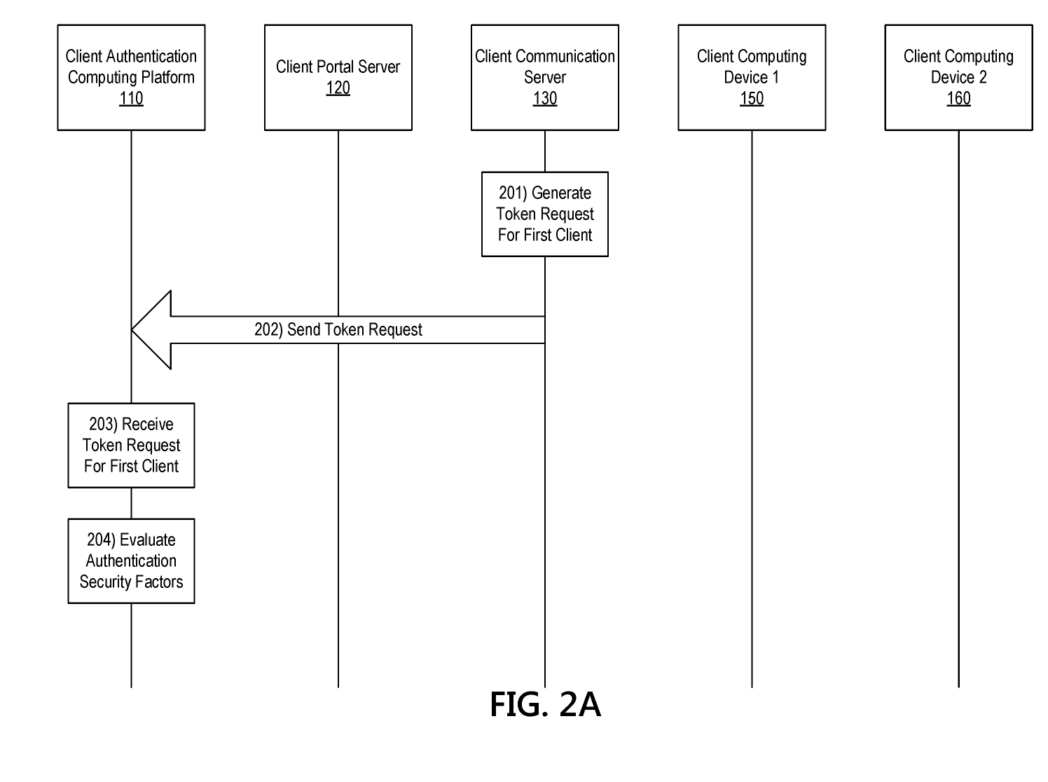

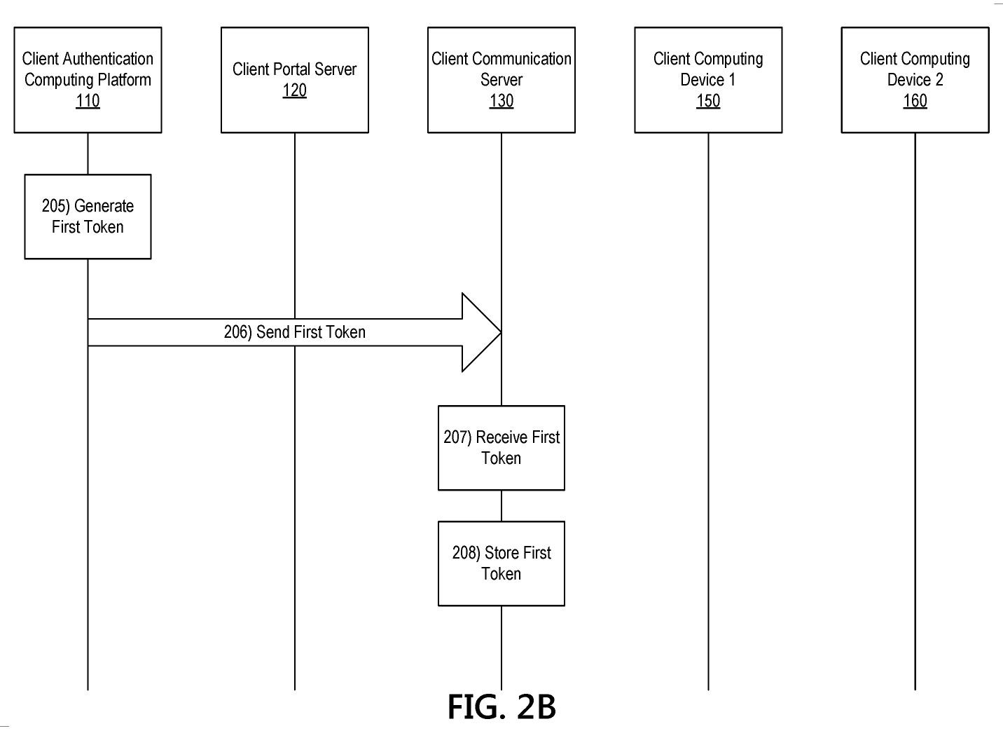

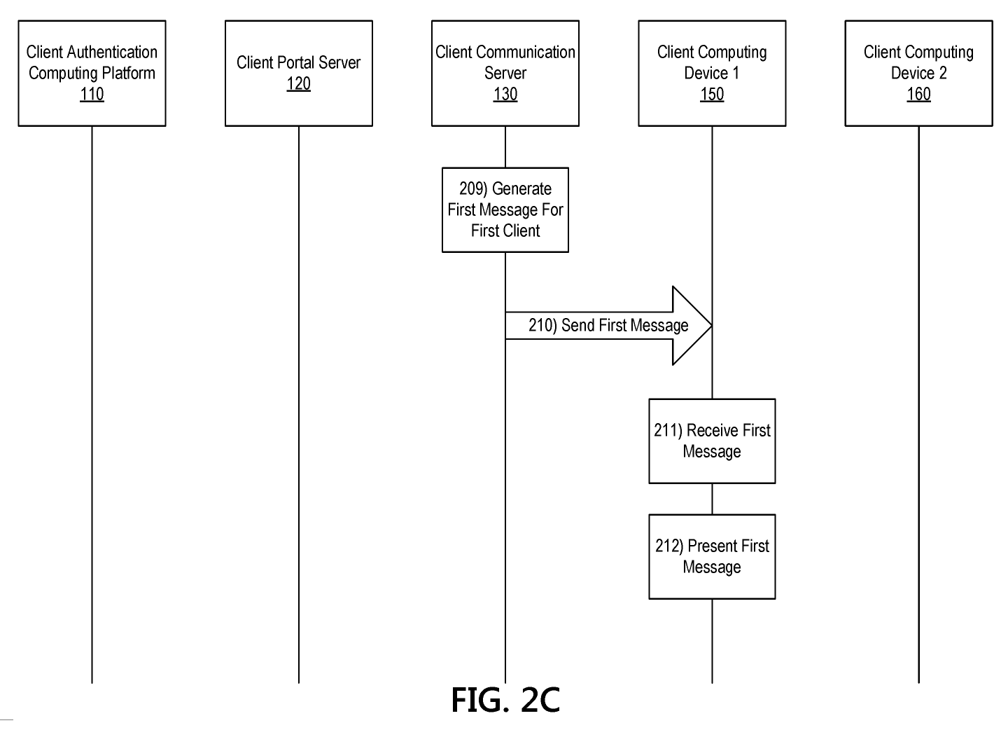

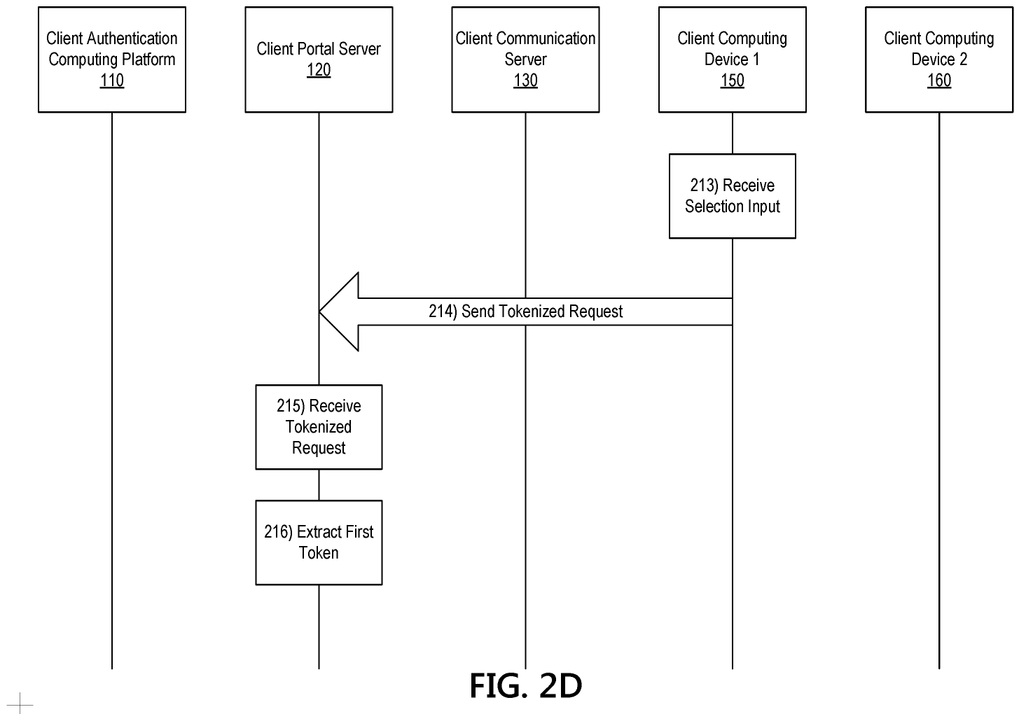

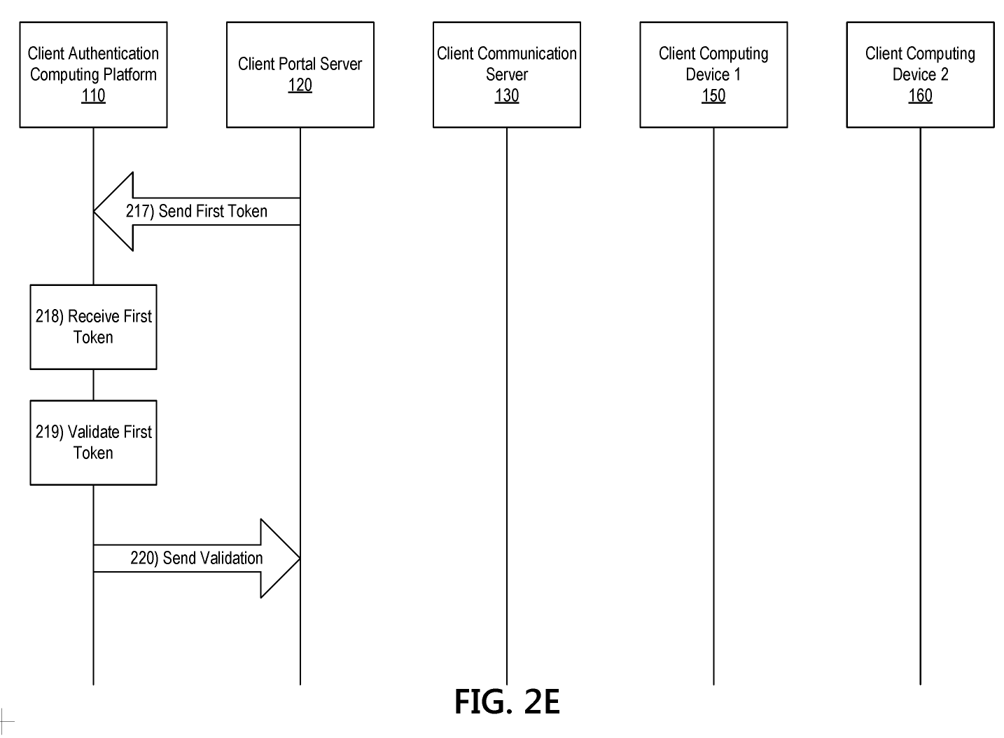

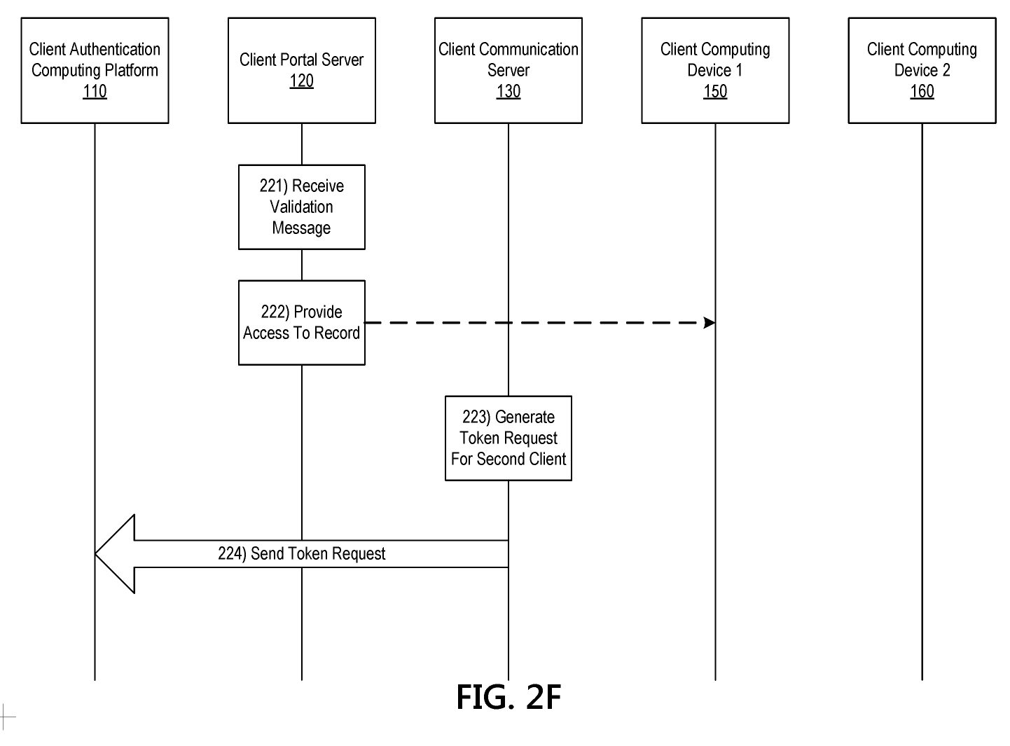

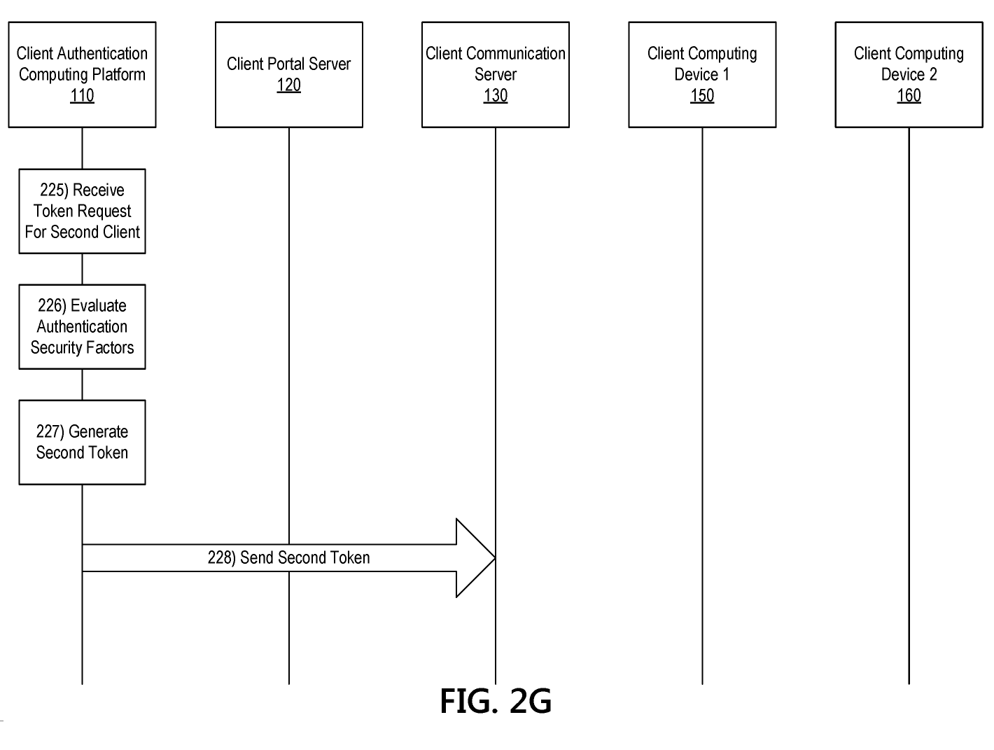

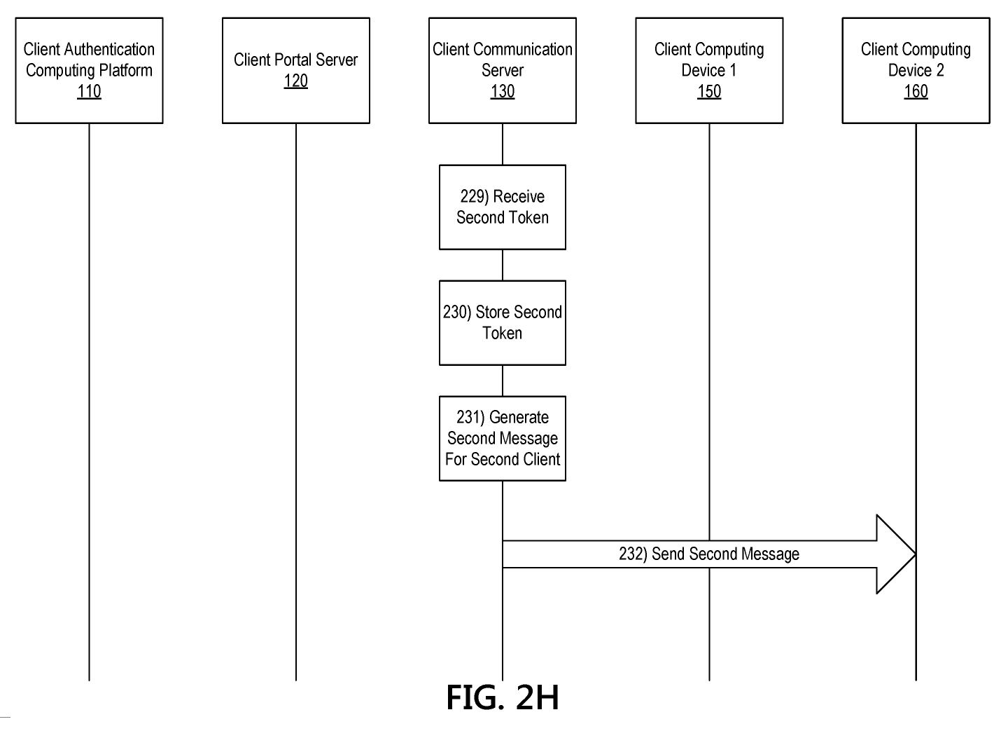

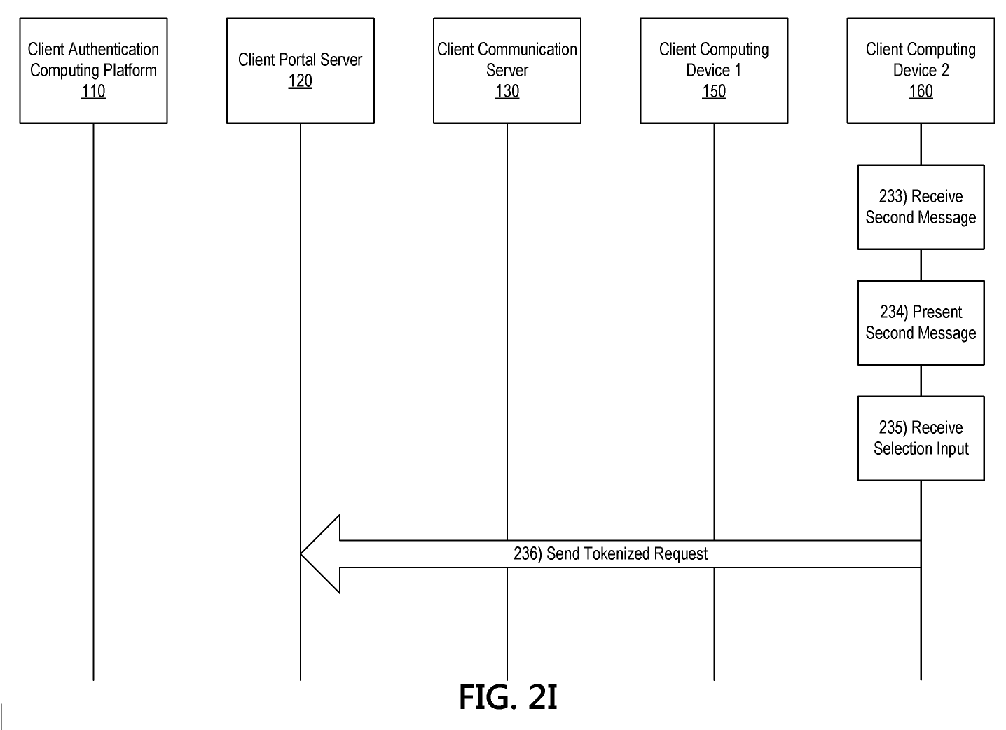

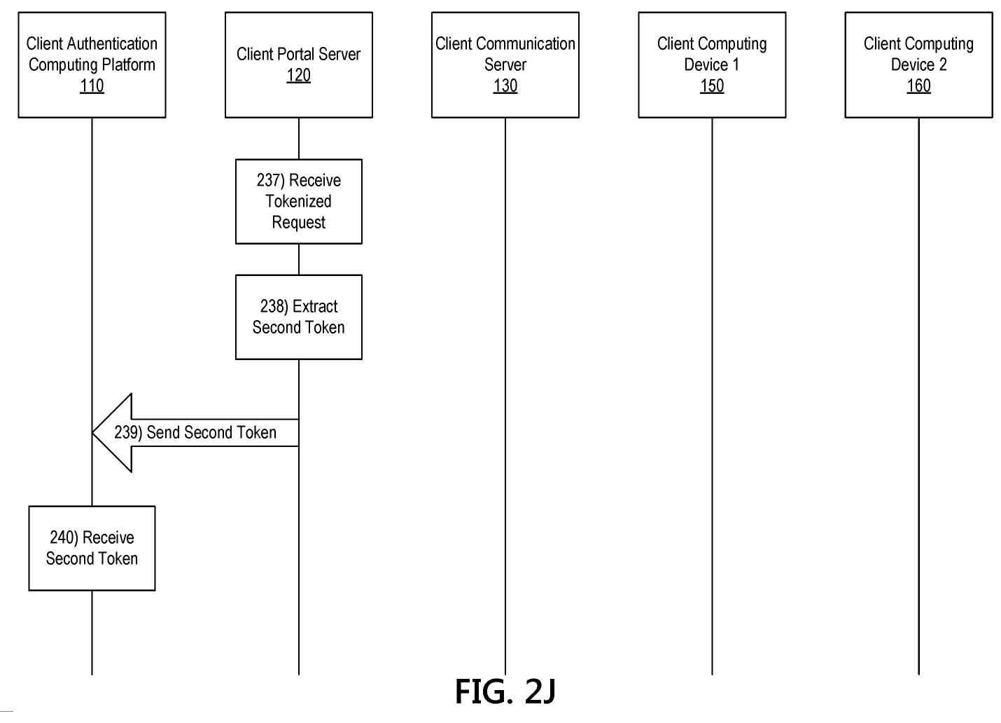

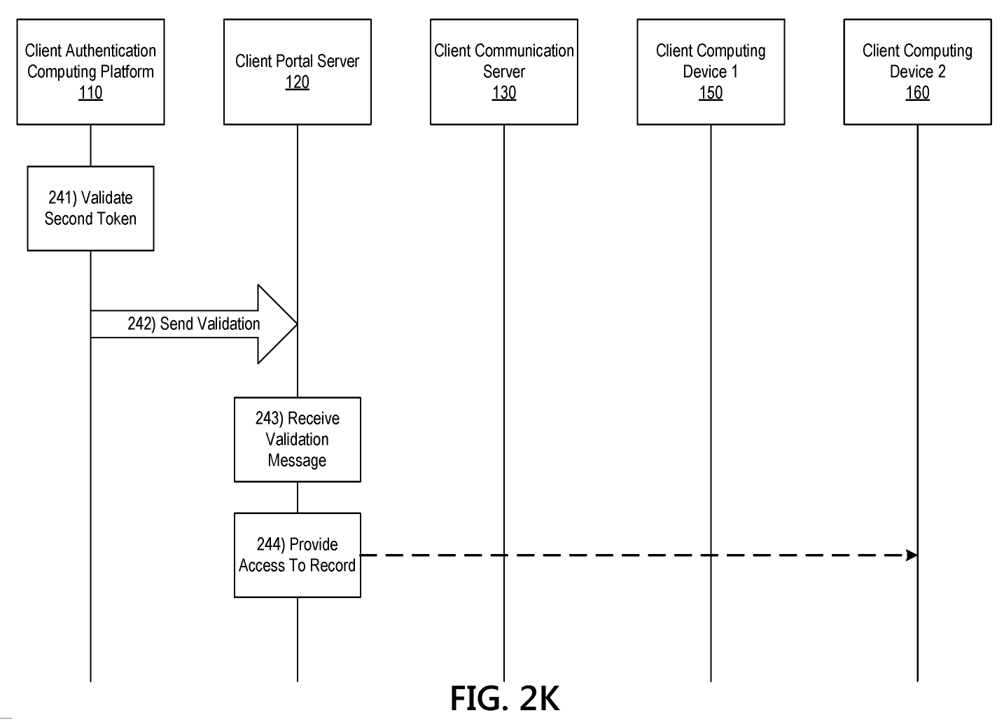

FIGS. 2A-2K depict an illustrative event sequence for authenticating clients using tokens in accordance with one or more example embodiments. As illustrated in greater detail below, the event sequence shown in FIGS. 2A-2K illustrates, among other things, how a computing platform, such as client authentication computing platform 110, may generate various tokens linked to various client-specific records for specific clients, share such tokens with other servers and devices, and validate such tokens so as to enable and/or otherwise provide authenticated access to the client-specific records for specific clients.

Referring to FIG. 2A, at step 201, client communication server 130 may generate a token request for a first client. For example, client communication server 130 may generate a token request for a client associated with client computing device 150. The first client may, for instance, be a customer of an organization, such as a financial institution, operating client authentication computing platform 110, client portal server 120, and/or client communication server 130. Additionally or alternatively, the first client may be a registered and/or authorized user of client computing device 150, and the organization operating client authentication computing platform 110, client portal server 120, and/or client communication server 130 may store and/or otherwise maintain one or more records correlating and/or otherwise associating client computing device 150 with the first client. At step 202, client communication server 130 may send the token request for the first client to client authentication computing platform 110.

At step 203, client authentication computing platform 110 may receive the token request for the first client from client communication server 130. For example, at step 203, client authentication computing platform 110 may receive, via the communication interface (e.g., communication interface 115), and from a client communication server (e.g., client communication server 130), a first token request requesting a token for a first client (which may, e.g., be associated with client computing device 150).

In some embodiments, the client communication server may be configured to send one or more messages to one or more client devices. For example, client communication server 130 may be configured to send one or more messages to one or more client devices (e.g., client computing device 150, client computing device 160, and/or one or more other client computing devices).

At step 204, client authentication computing platform 110 may evaluate one or more authentication security factors and/or other risk state information for the first client (e.g., to determine whether to generate or not generate a token for first client). For example, at step 204, client authentication computing platform 110 may evaluate one or more authentication security factors associated with the first client to determine to generate a first token linked to a first record associated with the first client.

In some embodiments, evaluating the one or more authentication security factors associated with the first client may include evaluating one or more of device login history information associated with the first client, network address login history information associated with the first client, or login trend information associated with the first client. For example, in evaluating the one or more authentication security factors associated with the first client (which may, e.g., be associated with client computing device 150), client authentication computing platform 110 may evaluate one or more of device login history information associated with the first client, network address login history information associated with the first client, and/or login trend information associated with the first client. The device login history information may, for instance, indicate what specific devices (e.g., client computing device 150 and/or one or more other devices) have previously been used to access one or more user accounts that are maintained for and/or otherwise associated with the first client. The network address login history information may, for instance, indicate what specific network addresses have previously been used to access one or more user accounts that are maintained for and/or otherwise associated with the first client. The login trend information may, for instance, indicate what specific days, times of day, locations, and/or other usage patterns have been used when accessing one or more user accounts that are maintained for and/or otherwise associated with the first client.

Referring to FIG. 2B, at step 205, client authentication computing platform 110 may generate a first token for the first client. For example, at step 205, based on receiving the first token request requesting the token for the first client, client authentication computing platform 110 may generate a first token linked to a first record associated with the first client. For instance, at step 205, client authentication computing platform 110 may generate the first token if a risk score and/or risk state associated with the first client and/or client computing device 150 is above a predetermined threshold and/or otherwise deemed acceptable (e.g., based on the evaluation of the one or more authentication security factors associated with the first client performed at step 204). Alternatively, client authentication computing platform 110 may generate and/or send an error message to client communication server 130 if a risk score and/or risk state associated with the first client and/or client computing device 150 is not above a predetermined threshold and/or otherwise deemed not acceptable (e.g., based on the evaluation of the one or more authentication security factors associated with the first client performed at step 204).

In some instances, the token generated by client authentication computing platform 110 (e.g., at step 205) may, for example, be and/or include a unique string of alphanumeric characters (which may, e.g., be sent, received, and/or read by one or more computing devices, may be appended and/or inserted into one or more uniform resource locators (URLs), and/or may be otherwise shared between computer systems and computing devices). In some instances, the token may be a JavaScript Open Notation (JSON) Web Token (JWT), for example, implementing a JSON-based open standard in accordance with RFC 7519. In some instances, the token (which may, e.g., be generated by client authentication computing platform 110 at step 205) may include one or more claims (which may, e.g., include information identifying an issuer of the token, a subject of the token, an audience of the token, an expiration time of the token, a not-before time of the token, a unique identifier of the token, and/or other information).

In some embodiments, the first record may include user account details information associated with the first client. For example, the first record (e.g., to which the first token generated by client authentication computing platform 110 at step 205 may be linked) may include user account details information associated with the first client (which may, e.g., be associated with client computing device 150). Such user account details information associated with the first client may, for instance, include one or more account statement documents associated with one or more accounts of the first client, one or more account-specific offers associated with one or more accounts of the first client, and/or other information that is specific to and/or otherwise associated with one or more accounts of the first client. For example, the first record may include a client-specific targeted deal, discount, and/or advertisement selected by the organization operating client authentication computing platform 110, client portal server 120, and/or client communication server 130 for the first client (which may, e.g., be associated with client computing device 150). As illustrated in greater detail below, the first token may be used to provide the client-specific targeted deal, discount, and/or advertisement selected by the organization operating client authentication computing platform 110, client portal server 120, and/or client communication server 130 to the first client (which may, e.g., be associated with client computing device 150), in a way that might expedite authentication of the first client and/or more efficiently allow the first client to view and/or use the client-specific targeted deal, discount, and/or advertisement selected by the organization operating client authentication computing platform 110, client portal server 120, and/or client communication server 130.

At step 206, client authentication computing platform 110 may send the first token for the first client to client communication server 130. For example, at step 206, client authentication computing platform 110 may send, via the communication interface (e.g., communication interface 115), and to the client communication server (e.g., client communication server 130), the first token linked to the first record associated with the first client. At step 207, client communication server 130 may receive the first token for the first client from client authentication computing platform 110. At step 208, client communication server 130 may store the first token for the first client received from client authentication computing platform 110.

Referring to FIG. 2C, at step 209, client communication server 130 may generate a first message for the first client. For example, at step 209, client communication server 130 may generate a message for the first client (which may, e.g., be associated with client computing device 150), and the message may include a URL or other link embedded with the first token and/or other content embedded with the first token. Additionally or alternatively, the message may include information identifying the first record (e.g., to which the first token is linked) and/or other information that may be accessed using the first token, as illustrated in greater detail below.

At step 210, client communication server 130 may send the first message for the first client to client computing device 150 (which may, e.g., be used by and/or otherwise associated with the first client). At step 211, client computing device 150 may receive the first message from client communication server 130.

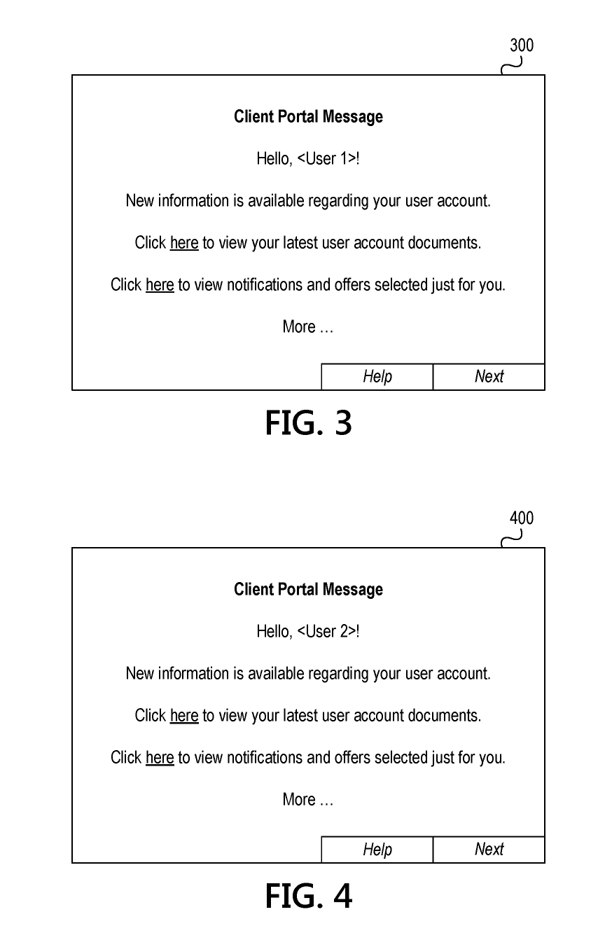

At step 212, client computing device 150 may present the first message received from client communication server 130. In presenting the first message received from client communication server 130, client computing device 150 may, for example, display and/or otherwise present a graphical user interface similar to graphical user interface 300, which is illustrated in FIG. 3. As seen in FIG. 3, graphical user interface 300 may include information included in and/or otherwise associated with the first message, such as a notification that new information related to a user account associated with the first client is available, as well as one or more tokenized links (e.g., “Click here to view your latest user account documents” and “Click here to view notifications and offers selected just for you”) which may have embedded and/or otherwise include the first token so as to facilitate and/or expedite authentication of the user of client computing device 150 when requesting access to information corresponding to the tokenized links.

Referring to FIG. 2D, at step 213, client computing device 150 may receive selection input (e.g., from the user of client computing device 150). For example, at step 213, client computing device 150 may receive input selecting a link embedded with the first token. Such input may, for instance, be received via the user interface presented by client computing device 150 at step 212.

At step 214, client computing device 150 may send a tokenized request to client portal server 120. For example, the selection input received by client computing device 150 at step 213 may include and/or correspond to the selection of a link directing client computing device 150 and/or a software application executing on client computing device 150, such as a mobile banking application or web browser, to a website hosted by, or other network address associated with, client portal server 120. The link may, in some instances, include an embedded token (e.g., the first token generated by client authentication computing platform 110), while in other instances, client computing device 150 may transmit and/or send a token associated with the link (e.g., the first token generated by client authentication computing platform 110) to client portal server 120 in sending a tokenized request to client portal server 120 at step 214.

At step 215, client portal server 120 may receive the tokenized request from client computing device 150. At step 216, client portal server 120 may extract the first token from the tokenized request received from client computing device 150. For example, client portal server 120 may isolate and/or identify the token received from client computing device 150 at step 215 and/or information associated with the token, such as one or more claims associated with the token (which may, e.g., include information identifying an issuer of the token, a subject of the token, an audience of the token, an expiration time of the token, a not-before time of the token, a unique identifier of the token, and/or other information).

Referring to FIG. 2E, at step 217, client portal server 120 may send the first token to client authentication computing platform 110. For example, at step 217, client portal server 120 may send the token extracted from the tokenized request received from client computing device 150 to client authentication computing platform 110 for validation by client authentication computing platform 110.

At step 218, client authentication computing platform 110 may receive the first token from client portal server 120. For example, at step 218, client authentication computing platform 110 may receive, via the communication interface (e.g., communication interface 115), and from a client portal server (e.g., client portal server 120), a first token validation request comprising the first token linked to the first record associated with the first client (which may, e.g., be associated with client computing device 150).

In some embodiments, the client portal server may be configured to provide one or more client portal interfaces to one or more client devices. For example, client portal server 120 may be configured to provide one or more client portal interfaces to one or more client devices (e.g., client computing device 150, client computing device 160, and/or one or more other client computing devices).

At step 219, client authentication computing platform 110 may validate the first token received from client portal server 120. For example, at step 219, based on receiving the first token validation request comprising the first token linked to the first record associated with the first client, client authentication computing platform 110 may validate the first token linked to the first record associated with the first client. In validating the token received from client portal server 120, client authentication computing platform 110 may, for example, determine and/or confirm that the token received from client portal server 120 is and/or corresponds to a legitimate token that was actually created, issued, and/or otherwise generated by client authentication computing platform 110, such as the first token generated by client authentication computing platform 110 at step 205. Additionally or alternatively, in validating the token received from client portal server 120, client authentication computing platform 110 may control and/or direct client portal server 120 and/or the computing device attempting to use the token (e.g., client computing device 150) to present and/or provide one or more authentication prompts to authenticate the user of the computing device attempting to use the token (e.g., client computing device 150) in instances where having the token on its own is not considered sufficient to authenticate the user of the computing device attempting to use the token (e.g., client computing device 150).

In some embodiments, validating the first token linked to the first record associated with the first client may include: sending, via the communication interface, and to a registered device associated with the first client, a one-time passcode; and validating one-time passcode input received from the client portal server. For example, in validating the first token linked to the first record associated with the first client at step 219, client authentication computing platform 110 may send, via the communication interface (e.g., communication interface 115), and to a registered device associated with the first client (e.g., client computing device 150), a one-time passcode. In addition, client authentication computing platform 110 may validate one-time passcode input received from the client portal server (e.g., client portal server 120). Such one-time passcode input received from the client portal server (e.g., client portal server 120) may, for example, include the one-time passcode sent to the registered device associated with the first client (e.g., client computing device 150) and may be entered by the user of the registered device associated with the first client (e.g., client computing device 150) via a user interface provided by the client portal server (e.g., client portal server 120).

In some embodiments, validating the first token linked to the first record associated with the first client may include: sending, via the communication interface, and to the client portal server, one or more security questions associated with the first client; and validating security question response input received from the client portal server. For example, in validating the first token linked to the first record associated with the first client at step 219, client authentication computing platform 110 may send, via the communication interface (e.g., communication interface 115), and to the client portal server (e.g., client portal server 120), one or more security questions associated with the first client. In addition, client authentication computing platform 110 may validate security question response input received from the client portal server (e.g., client portal server 120). Such security question response input received from the client portal server (e.g., client portal server 120) may, for example, include one or more responses to the one or more security questions associated with the first client, and such responses may be provided by the user of the registered device associated with the first client (e.g., client computing device 150) via a user interface provided by the client portal server (e.g., client portal server 120).

At step 220, client authentication computing platform 110 may send a validation message to client portal server 120 (e.g., based on validating the first token received from client portal server 120 at step 219). For example, at step 220, based on validating the first token linked to the first record associated with the first client, client authentication computing platform 110 may send, via the communication interface (e.g., communication interface 115), and to the client portal server (e.g., client portal server 120), a first token validation message directing the client portal server (e.g., client portal server 120) to provide the first record associated with the first client to the first client. For instance, the first token validation message may direct the client portal server (e.g., client portal server 120) to provide the first record associated with the first client to client computing device 150 to enable the user of client computing device 150 (who may, e.g., be the first client) to view, interact with, and/or otherwise access the first record associated with the first client.

In some instances, the token validation message (which may, e.g., be sent by client authentication computing platform 110 at step 220) may include some or all of the information to be presented to the first client by client computing device 150, such as one or more account statement documents associated with one or more accounts of the first client, one or more account-specific offers associated with one or more accounts of the first client, and/or other information that is specific to and/or otherwise associated with one or more accounts of the first client. If, for instance, client authentication computing platform 110 is not able to validate the first token received from client portal server 120 at step 219, then instead of sending a validation message to client portal server 120 at step 220, client authentication computing platform 110 instead may generate and/or send an error message to client portal server 120.

Referring to FIG. 2F, at step 221, client portal server 120 may receive the validation message from client authentication computing platform 110. At step 222, client portal server 120 may provide access to the first record and/or other account-specific details associated with the first client. For example, at step 222, client portal server 120 may provide client computing device 150 with access to the first record and/or other account-specific details associated with the first client, in accordance with and/or otherwise based on the token validation message (which may, e.g., be sent by client authentication computing platform 110 at step 220). In some instances, prior to providing client computing device 150 with access to the first record and/or other account-specific details associated with the first client, client portal server 120 may require client computing device 150 and/or the user of client computing device 150 to provide one or more authentication credentials for verification, in accordance with one or more authentication requirements specified in the token validation message (which may, e.g., be sent by client authentication computing platform 110 at step 220). For example, prior to providing client computing device 150 with access to the first record and/or other account-specific details associated with the first client, client portal server 120 may require client computing device 150 and/or the user of client computing device 150 to provide a one-time passcode, one or more challenge questions responses, username entry (e.g., account username, online banking username), or the like, in accordance with one or more authentication requirements specified in the token validation message (which may, e.g., be sent by client authentication computing platform 110 at step 220).

Subsequently, one or more steps of the event sequence discussed above may be repeated with respect to a second client. Although such steps are illustrated separately and following the steps performed with respect to the first client, various steps may be performed in a different order, such that client authentication computing platform 110 may, for instance, generate tokens for multiple clients in batches, share such tokens in batches, and/or process requests to provide authenticated access based on such tokens in real-time as such tokens are received for validation.

Continuing to refer to FIG. 2F, at step 223, client communication server 130 may generate a token request for a second client. For example, client communication server 130 may generate a token request for a client associated with client computing device 160. The second client may, for instance, be a customer of an organization, such as a financial institution, operating client authentication computing platform 110, client portal server 120, and/or client communication server 130. Additionally or alternatively, the second client may be a registered and/or authorized user of client computing device 160, and the organization operating client authentication computing platform 110, client portal server 120, and/or client communication server 130 may store and/or otherwise maintain one or more records correlating and/or otherwise associating client computing device 160 with the second client. At step 224, client communication server 130 may send the token request for the second client to client authentication computing platform 110.

Referring to FIG. 2G, at step 225, client authentication computing platform 110 may receive the token request for the second client from client communication server 130. For example, at step 225, client authentication computing platform 110 may receive, via the communication interface (e.g., communication interface 115), and from the client communication server (e.g., client communication server 130), a second token request requesting a token for a second client (which may, e.g., be associated with client computing device 160) different from the first client (which may, e.g., be associated with client computing device 150).

At step 226, client authentication computing platform 110 may evaluate one or more authentication security factors and/or other risk state information for the second client (e.g., to determine whether to generate or not generate a token for second client). For example, at step 226, client authentication computing platform 110 may evaluate one or more authentication security factors associated with the second client to determine to generate a second token linked to a second record associated with the second client.

In some embodiments, evaluating the one or more authentication security factors associated with the second client may include evaluating one or more of device login history information associated with the second client, network address login history information associated with the second client, or login trend information associated with the second client.

For example, in evaluating the one or more authentication security factors associated with the second client (which may, e.g., be associated with client computing device 160), client authentication computing platform 110 may evaluate one or more of device login history information associated with the second client, network address login history information associated with the second client, and/or login trend information associated with the second client. The device login history information may, for instance, indicate what specific devices (e.g., client computing device 160 and/or one or more other devices) have previously been used to access one or more user accounts that are maintained for and/or otherwise associated with the second client. The network address login history information may, for instance, indicate what specific network addresses have previously been used to access one or more user accounts that are maintained for and/or otherwise associated with the second client. The login trend information may, for instance, indicate what specific days, times of day, locations, and/or other usage patterns have been used when accessing one or more user accounts that are maintained for and/or otherwise associated with the second client.

At step 227, client authentication computing platform 110 may generate a second token for the second client. For example, at step 227, based on receiving the second token request requesting the token for the second client, client authentication computing platform 110 may generate a second token linked to a second record associated with the second client. For instance, at step 227, client authentication computing platform 110 may generate the second token if a risk score and/or risk state associated with the second client and/or client computing device 160 is above a predetermined threshold and/or otherwise deemed acceptable (e.g., based on the evaluation of the one or more authentication security factors associated with the second client performed at step 226). Alternatively, client authentication computing platform 110 may generate and/or send an error message to client communication server 130 if a risk score and/or risk state associated with the second client and/or client computing device 160 is not above a predetermined threshold and/or otherwise deemed not acceptable (e.g., based on the evaluation of the one or more authentication security factors associated with the second client performed at step 226).

In some instances, the token generated by client authentication computing platform 110 (e.g., at step 227) may, for example, be and/or include a unique string of alphanumeric characters (which may, e.g., be sent, received, and/or read by one or more computing devices, may be appended and/or inserted into one or more uniform resource locators, and/or may be otherwise shared between computer systems and computing devices). In some instances, the token may be a JSON Web Token, for example, implementing a JSON-based open standard in accordance with RFC 7519. In some instances, the token (which may, e.g., be generated by client authentication computing platform 110 at step 227) may include one or more claims (which may, e.g., include information identifying an issuer of the token, a subject of the token, an audience of the token, an expiration time of the token, a not-before time of the token, a unique identifier of the token, and/or other information).

In some embodiments, the second record may include user account details information associated with the second client. For example, the second record (e.g., to which the second token generated by client authentication computing platform 110 at step 227 may be linked) may include user account details information associated with the second client (which may, e.g., be associated with client computing device 160). Such user account details information associated with the second client may, for instance, include one or more account statement documents associated with one or more accounts of the second client, one or more account-specific offers associated with one or more accounts of the second client, and/or other information that is specific to and/or otherwise associated with one or more accounts of the second client. For example, the second record may include a client-specific targeted deal, discount, and/or advertisement selected by the organization operating client authentication computing platform 110, client portal server 120, and/or client communication server 130 for the second client (which may, e.g., be associated with client computing device 160). As illustrated in greater detail below, the second token may be used to provide the client-specific targeted deal, discount, and/or advertisement selected by the organization operating client authentication computing platform 110, client portal server 120, and/or client communication server 130 to the second client (which may, e.g., be associated with client computing device 160), in a way that might expedite authentication of the second client and/or more efficiently allow the second client to view and/or use the client-specific targeted deal, discount, and/or advertisement selected by the organization operating client authentication computing platform 110, client portal server 120, and/or client communication server 130.

At step 228, client authentication computing platform 110 may send the second token for the second client to client communication server 130. For example, at step 228, client authentication computing platform 110 may send, via the communication interface (e.g., communication interface 115), and to the client communication server (e.g., client communication server 130), the second token linked to the second record associated with the second client.

Referring to FIG. 2H, at step 229, client communication server 130 may receive the second token for the second client from client authentication computing platform 110. At step 230, client communication server 130 may store the second token for the second client received from client authentication computing platform 110.

At step 231, client communication server 130 may generate a second message for the second client. For example, at step 231, client communication server 130 may generate a message for the second client (which may, e.g., be associated with client computing device 160), and the message may include a URL or other link embedded with the second token and/or other content embedded with the second token. Additionally or alternatively, the message may include information identifying the second record (e.g., to which the second token is linked) and/or other information that may be accessed using the second token, as illustrated in greater detail below. At step 232, client communication server 130 may send the second message for the second client to client computing device 160 (which may, e.g., be used by and/or otherwise associated with the second client).

Referring to FIG. 2I, at step 233, client computing device 160 may receive the second message from client communication server 130. At step 234, client computing device 160 may present the second message received from client communication server 130. In presenting the second message received from client communication server 130, client computing device 160 may, for example, display and/or otherwise present a graphical user interface similar to graphical user interface 400, which is illustrated in FIG. 4. As seen in FIG. 4, graphical user interface 400 may include information included in and/or otherwise associated with the second message, such as a notification that new information related to a user account associated with the second client is available, as well as one or more tokenized links (e.g., “Click here to view your latest user account documents” and “Click here to view notifications and offers selected just for you”) which may have embedded and/or otherwise include the second token so as to facilitate and/or expedite authentication of the user of client computing device 160 when requesting access to information corresponding to the tokenized links.

At step 235, client computing device 160 may receive selection input (e.g., from the user of client computing device 160). For example, at step 235, client computing device 160 may receive input selecting a link embedded with the second token. Such input may, for instance, be received via the user interface presented by client computing device 160 at step 234.

At step 236, client computing device 160 may send a tokenized request to client portal server 120. For example, the selection input received by client computing device 160 at step 235 may include and/or correspond to the selection of a link directing client computing device 160 and/or a software application executing on client computing device 160, such as a mobile banking application or web browser, to a website hosted by, or other network address associated with, client portal server 120. The link may, in some instances, include an embedded token (e.g., the second token generated by client authentication computing platform 110), while in other instances, client computing device 160 may transmit and/or send a token associated with the link (e.g., the second token generated by client authentication computing platform 110) to client portal server 120 in sending a tokenized request to client portal server 120 at step 236.

Referring to FIG. 2J, at step 237, client portal server 120 may receive the tokenized request from client computing device 160. At step 238, client portal server 120 may extract the second token from the tokenized request received from client computing device 160. For example, client portal server 120 may isolate and/or identify the token received from client computing device 160 at step 237 and/or information associated with the token, such as one or more claims associated with the token (which may, e.g., include information identifying an issuer of the token, a subject of the token, an audience of the token, an expiration time of the token, a not-before time of the token, a unique identifier of the token, and/or other information).

At step 239, client portal server 120 may send the second token to client authentication computing platform 110. For example, at step 239, client portal server 120 may send the token extracted from the tokenized request received from client computing device 160 to client authentication computing platform 110 for validation by client authentication computing platform 110.

At step 240, client authentication computing platform 110 may receive the second token from client portal server 120. For example, at step 240, client authentication computing platform 110 may receive, via the communication interface (e.g., communication interface 115), and from the client portal server (e.g., client portal server 120), a second token validation request comprising the second token linked to the second record associated with the second client (which may, e.g., be associated with client computing device 160).

Referring to FIG. 2K, at step 241, client authentication computing platform 110 may validate the second token received from client portal server 120. For example, at step 241, based on receiving the second token validation request comprising the second token linked to the second record associated with the second client, client authentication computing platform 110 may validate the second token linked to the second record associated with the second client. In validating the token received from client portal server 120, client authentication computing platform 110 may, for example, determine and/or confirm that the token received from client portal server 120 is and/or corresponds to a legitimate token that was actually created, issued, and/or otherwise generated by client authentication computing platform 110, such as the second token generated by client authentication computing platform 110 at step 227. Additionally or alternatively, in validating the token received from client portal server 120, client authentication computing platform 110 may control and/or direct client portal server 120 and/or the computing device attempting to use the token (e.g., client computing device 160) to present and/or provide one or more authentication prompts to authenticate the user of the computing device attempting to use the token (e.g., client computing device 160) in instances where having the token on its own is not considered sufficient to authenticate the user of the computing device attempting to use the token (e.g., client computing device 160).

In some embodiments, validating the second token linked to the second record associated with the second client may include: sending, via the communication interface, and to a registered device associated with the second client, a one-time passcode; and validating one-time passcode input received from the client portal server. For example, in validating the second token linked to the second record associated with the second client at step 241, client authentication computing platform 110 may send, via the communication interface (e.g., communication interface 115), and to a registered device associated with the second client (e.g., client computing device 160), a one-time passcode. In addition, client authentication computing platform 110 may validate one-time passcode input received from the client portal server (e.g., client portal server 120). Such one-time passcode input received from the client portal server (e.g., client portal server 120) may, for example, include the one-time passcode sent to the registered device associated with the second client (e.g., client computing device 160) and may be entered by the user of the registered device associated with the second client (e.g., client computing device 160) via a user interface provided by the client portal server (e.g., client portal server 120).

In some embodiments, validating the second token linked to the second record associated with the second client may include: sending, via the communication interface, and to the client portal server, one or more security questions associated with the second client; and validating security question response input received from the client portal server. For example, in validating the second token linked to the second record associated with the second client at step 241, client authentication computing platform 110 may send, via the communication interface (e.g., communication interface 115), and to the client portal server (e.g., client portal server 120), one or more security questions associated with the second client. In addition, client authentication computing platform 110 may validate security question response input received from the client portal server (e.g., client portal server 120). Such security question response input received from the client portal server (e.g., client portal server 120) may, for example, include one or more responses to the one or more security questions associated with the second client, and such responses may be provided by the user of the registered device associated with the second client (e.g., client computing device 160) via a user interface provided by the client portal server (e.g., client portal server 120).

At step 242, client authentication computing platform 110 may send a validation message to client portal server 120 (e.g., based on validating the second token received from client portal server 120 at step 241). For example, at step 242, based on validating the second token linked to the second record associated with the second client, client authentication computing platform 110 may send, via the communication interface (e.g., communication interface 115), and to the client portal server (e.g., client portal server 120), a second token validation message directing the client portal server (e.g., client portal server 120) to provide the second record associated with the second client to the second client. For instance, the second token validation message may direct the client portal server (e.g., client portal server 120) to provide the second record associated with the second client to client computing device 160 to enable the user of client computing device 160 (who may, e.g., be the second client) to view, interact with, and/or otherwise access the second record associated with the second client.

In some instances, the token validation message (which may, e.g., be sent by client authentication computing platform 110 at step 242) may include some or all of the information to be presented to the second client by client computing device 160, such as one or more account statement documents associated with one or more accounts of the second client, one or more account-specific offers associated with one or more accounts of the second client, and/or other information that is specific to and/or otherwise associated with one or more accounts of the second client. If, for instance, client authentication computing platform 110 is not able to validate the second token received from client portal server 120 at step 240, then instead of sending a validation message to client portal server 120 at step 242, client authentication computing platform 110 instead may generate and/or send an error message to client portal server 120.

At step 243, client portal server 120 may receive the validation message from client authentication computing platform 110. At step 244, client portal server 120 may provide access to the second record and/or other account-specific details associated with the second client. For example, at step 244, client portal server 120 may provide client computing device 160 with access to the second record and/or other account-specific details associated with the second client, in accordance with and/or otherwise based on the token validation message (which may, e.g., be sent by client authentication computing platform 110 at step 242). In some instances, prior to providing client computing device 160 with access to the second record and/or other account-specific details associated with the second client, client portal server 120 may require client computing device 160 and/or the user of client computing device 160 to provide one or more authentication credentials for verification, in accordance with one or more authentication requirements specified in the token validation message (which may, e.g., be sent by client authentication computing platform 110 at step 242). For example, prior to providing client computing device 160 with access to the second record and/or other account-specific details associated with the second client, client portal server 120 may require client computing device 160 and/or the user of client computing device 160 to provide a one-time passcode, one or more challenge questions responses, username entry (e.g., account username, online banking username), or the like, in accordance with one or more authentication requirements specified in the token validation message (which may, e.g., be sent by client authentication computing platform 110 at step 242).

Subsequently, one or more steps of the event sequence discussed above may be repeated with respect to one or more additional clients. In addition, and as noted above, various steps may be performed in a different order, such that client authentication computing platform 110 may, for instance, generate tokens for multiple clients in batches, share such tokens in batches, and/or process requests to provide authenticated access based on such tokens in real-time as such tokens are received for validation

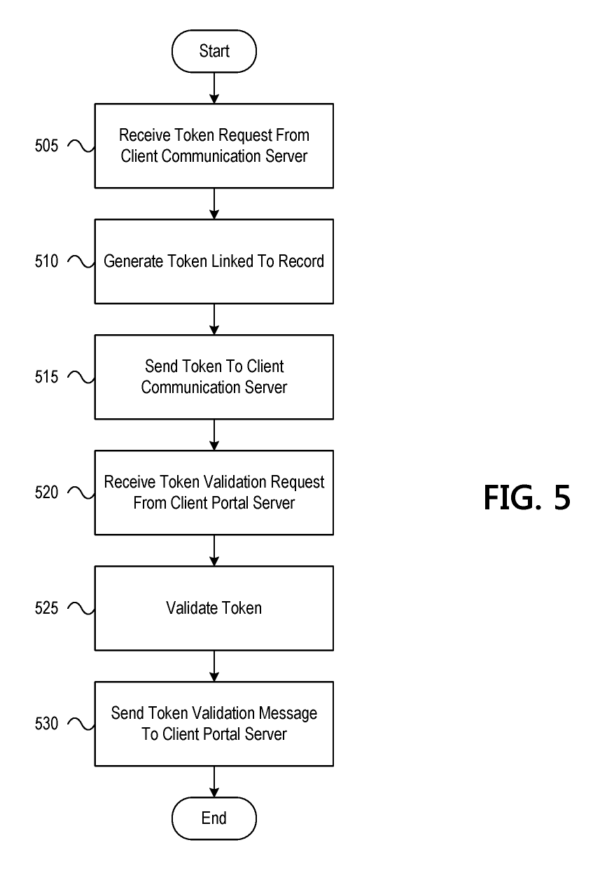

FIG. 5 depicts an illustrative method for authenticating clients using tokens in accordance with one or more example embodiments. Referring to FIG. 5, at step 505, a computing platform having at least one processor, a memory, and a communication interface may receive, via the communication interface, and from a client communication server, a first token request requesting a token for a first client. At step 510, based on receiving the first token request requesting the token for the first client, the computing platform may generate a first token linked to a first record associated with the first client. At step 515, the computing platform may send, via the communication interface, and to the client communication server, the first token linked to the first record associated with the first client. At step 520, the computing platform may receive, via the communication interface, and from a client portal server, a first token validation request comprising the first token linked to the first record associated with the first client. At step 525, based on receiving the first token validation request comprising the first token linked to the first record associated with the first client, the computing platform may validate the first token linked to the first record associated with the first client. At step 530, based on validating the first token linked to the first record associated with the first client, the computing platform may send, via the communication interface, and to the client portal server, a first token validation message directing the client portal server to provide the first record associated with the first client to the first client.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, and from a client communication server, a first token request requesting a token for a first client;
based on receiving the first token request requesting the token for the first client, generate a first token linked to a first record associated with the first client;
send, via the communication interface, and to the client communication server, the first token linked to the first record associated with the first client;
receive, via the communication interface, and from a client portal server, a first token validation request comprising the first token linked to the first record associated with the first client;
based on receiving the first token validation request comprising the first token linked to the first record associated with the first client, validate the first token linked to the first record associated with the first client; and
based on validating the first token linked to the first record associated with the first client, send, via the communication interface, and to the client portal server, a first token validation message directing the client portal server to provide the first record associated with the first client to the first client.

2. The computing platform of claim 1, wherein the memory stores additional computer-readable instructions that, when executed by the at least one processor, cause the computing platform to:
prior to generating the first token linked to the first record associated with the first client, evaluate one or more authentication security factors associated with the first client to determine to generate the first token linked to the first record associated with the first client.

3. The computing platform of claim 2, wherein evaluating the one or more authentication security factors associated with the first client comprises evaluating one or more of device login history information associated with the first client, network address login history information associated with the first client, or login trend information associated with the first client.

4. The computing platform of claim 2, wherein the first record comprises user account details information associated with the first client.

5. The computing platform of claim 2, wherein the client communication server is configured to send one or more messages to one or more client devices.

6. The computing platform of claim 2, wherein the client portal server is configured to provide one or more client portal interfaces to one or more client devices.

7. The computing platform of claim 2, wherein validating the first token linked to the first record associated with the first client comprises:
sending, via the communication interface, and to a registered device associated with the first client, a one-time passcode; and
validating one-time passcode input received from the client portal server.

8. The computing platform of claim 2, wherein validating the first token linked to the first record associated with the first client comprises:
sending, via the communication interface, and to the client portal server, one or more security questions associated with the first client; and
validating security question response input received from the client portal server.

9. The computing platform of claim 2, wherein the memory stores additional computer-readable instructions that, when executed by the at least one processor, cause the computing platform to:
receive, via the communication interface, and from the client communication server, a second token request requesting a token for a second client different from the first client;
based on receiving the second token request requesting the token for the second client, generate a second token linked to a second record associated with the second client;
send, via the communication interface, and to the client communication server, the second token linked to the second record associated with the second client;
receive, via the communication interface, and from the client portal server, a second token validation request comprising the second token linked to the second record associated with the second client;
based on receiving the second token validation request comprising the second token linked to the second record associated with the second client, validate the second token linked to the second record associated with the second client; and
based on validating the second token linked to the second record associated with the second client, send, via the communication interface, and to the client portal server, a second token validation message directing the client portal server to provide the second record associated with the second client to the second client.

10. The computing platform of claim 9, wherein the memory stores additional computer-readable instructions that, when executed by the at least one processor, cause the computing platform to:
prior to generating the second token linked to the second record associated with the second client, evaluate one or more authentication security factors associated with the second client to determine to generate the second token linked to the second record associated with the second client.

11. The computing platform of claim 10, wherein evaluating the one or more authentication security factors associated with the second client comprises evaluating one or more of device login history information associated with the second client, network address login history information associated with the second client, or login trend information associated with the second client.

12. The computing platform of claim 10, wherein the second record comprises user account details information associated with the second client.

13. The computing platform of claim 10, wherein validating the second token linked to the second record associated with the second client comprises:
sending, via the communication interface, and to a registered device associated with the second client, a one-time passcode; and
validating one-time passcode input received from the client portal server.

14. The computing platform of claim 10, wherein validating the second token linked to the second record associated with the second client comprises:
sending, via the communication interface, and to the client portal server, one or more security questions associated with the second client; and
validating security question response input received from the client portal server.

15. A method, comprising:
at a computing platform comprising at least one processor, memory, and a communication interface:
receiving, by the at least one processor, via the communication interface, and from a client communication server, a first token request requesting a token for a first client;
based on receiving the first token request requesting the token for the first client, generating, by the at least one processor, a first token linked to a first record associated with the first client;
sending, by the at least one processor, via the communication interface, and to the client communication server, the first token linked to the first record associated with the first client;
receiving, by the at least one processor, via the communication interface, and from a client portal server, a first token validation request comprising the first token linked to the first record associated with the first client;
based on receiving the first token validation request comprising the first token linked to the first record associated with the first client, validating, by the at least one processor, the first token linked to the first record associated with the first client; and
based on validating the first token linked to the first record associated with the first client, sending, by the at least one processor, via the communication interface, and to the client portal server, a first token validation message directing the client portal server to provide the first record associated with the first client to the first client.

16. The method of claim 15, comprising:
prior to generating the first token linked to the first record associated with the first client, evaluating, by the at least one processor, one or more authentication security factors associated with the first client to determine to generate the first token linked to the first record associated with the first client.

17. The method of claim 16, wherein evaluating the one or more authentication security factors associated with the first client comprises evaluating one or more of device login history information associated with the first client, network address login history information associated with the first client, or login trend information associated with the first client.

18. The method of claim 16, wherein the first record comprises user account details information associated with the first client.

19. The method of claim 16,
wherein the client communication server is configured to send one or more messages to one or more client devices, and
wherein the client portal server is configured to provide one or more client portal interfaces to one or more client devices.

20. One or more non-transitory computer-readable media storing instructions that, when executed by a computing platform comprising at least one processor, memory, and a communication interface, cause the computing platform to:
receive, via the communication interface, and from a client communication server, a first token request requesting a token for a first client;
based on receiving the first token request requesting the token for the first client, generate a first token linked to a first record associated with the first client;
send, via the communication interface, and to the client communication server, the first token linked to the first record associated with the first client;
receive, via the communication interface, and from a client portal server, a first token validation request comprising the first token linked to the first record associated with the first client;
based on receiving the first token validation request comprising the first token linked to the first record associated with the first client, validate the first token linked to the first record associated with the first client; and
based on validating the first token linked to the first record associated with the first client, send, via the communication interface, and to the client portal server, a first token validation message directing the client portal server to provide the first record associated with the first client to the first client.
